(19) United States
(12) Patent Application Publication
(10) Pub. No.: US 2022/0315839 A1
(43) Pub. Date: Oct. 6, 2022

(54) LIQUID CRYSTAL DISPLAY LAYER, LIQUID CRYSTAL MEDIUM COMPOSITION AND MANUFACTURING METHOD THEREOF

(71) Applicant: TCL China Star Optoelectronics Technology Co., Ltd., Shenzhen (CN)

(72) Inventors: Hongquan WEI, Shenzhen (CN); Tejen TSENG, Shenzhen (CN); Dong LIAO, Shenzhen (CN)

(21) Appl. No.: 16/763,308

(22) PCT Filed: Dec. 27, 2019
(86) PCT No.: PCT/CN2019/129113

§ 371 Date: May 12, 2020

(30) Foreign Application Priority Data
Dec. 16, 2019 (CN) 201911295599.5

(51) Int. Cl. C09K 19/54; C09K 19/56; G02F 1/1337; G02F 1/1334

(52) U.S. Cl. CPC C09K 19/544; C09K 19/56; G02F 1/1337; G02F 1/1334; C09K 2019/548; C09K 2019/546

(57) ABSTRACT

The present invention provides a liquid crystal display layer including an upper substrate layer, a lower substrate layer, and a transparent electrode disposed inside the upper substrate layer and the lower substrate layer, respectively. An alignment film is attached to each of the transparent electrodes, and a liquid crystal medium composition is distributed between the alignment films. At least two polymerizable monomers are mixed in the liquid crystal medium composition, each of the polymerizable monomers includes at least two ring structures or fused ring structures, and two reactive functional groups are directly or indirectly connected to the ring structures. The present invention further provides a manufacturing method of a liquid crystal medium composition.

### FIELD OF INVENTION

The present invention relates to the field of optoelectronic technologies, and in particular, to a liquid crystal display layer, a liquid crystal medium composition and a manufacturing method thereof.

### BACKGROUND OF INVENTION

Thin film transistor liquid crystal displays (TFT-LCDs) have been widely used for their advantages such as light weight, low power consumptions, and good image qualities. In recent years, various liquid crystal displays have been developed, which have wide viewing angles, high contrast, and high image qualities. The liquid crystal displays have become an integral part of people's lives. Common display modes are TN/IPS/VA types. The VA type is divided into MVA/PVA/PSVA, etc. MVA has problems of insufficient contrast and low transmittance. PVA has a problem of slow response time. PSVA (polymer-stabilized vertical alignment) has excellent characteristics of fast response, high contrast, and high penetration. Therefore, PSVA mode is still a first choice among large-size LCD technologies.

### Technical Problem

A liquid crystal medium composition in PSVA technologies is usually composed of negative liquid crystal materials and polymerizable monomers (RMs) polymerized under ultraviolet. During PSVA processes, the polymerizable monomers occur phase separations from liquid crystal mediums, and polymerizable reactions occur on a PI surface under a condition of ultraviolet to form polymer particles. However, in order to increase production capacities of display panels, it is necessary to shorten an irradiation time of the ultraviolet.

Shortening the irradiation time of the ultraviolet can be obtained by increasing intensities of the ultraviolet. However, disadvantages of this method are: 1) increase power consumption, increase power costs, increase lamp losses, and shorten lamp life; 2) if a reaction is too fast, particle sizes of the polymer particles formed by aggregation will be too large, and problems such as light leakage caused by broken spots will be caused.

### Technical Solution

The present invention provides a liquid crystal display layer comprising an upper substrate layer, a lower substrate layer, and transparent electrodes disposed inside the upper substrate layer and the lower substrate layer, respectively; wherein an alignment film is attached to each of the transparent electrodes, and a liquid crystal medium composition is distributed between the alignment films; and wherein at least two polymerizable monomers are mixed in the liquid crystal medium composition, each of the polymerizable monomers comprises at least two ring structures or fused ring structures, and two reactive functional groups directly or indirectly connected to the ring structures.

A structural formula of the polymerizable monomer is any one or more of following formulas:

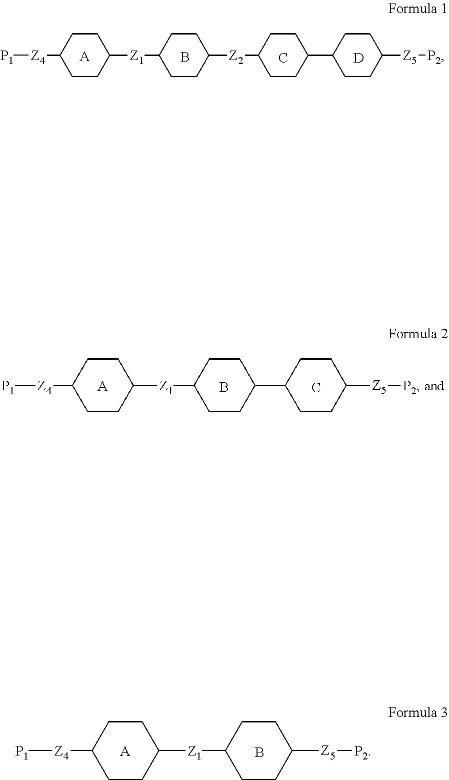

Preferably, the P1 and P2 are a same or different, and are selected from methacrylate, acrylate, vinyloxy, or epoxy; the Z1, Z2, Z3, Z4, and Z5 are a same or different, and are selected from a single bond or an alkylene group having 1 to 5 carbon atoms, wherein any of methylene groups may be replaced by —O—, —S—, —CO—, —COO—, —OCO—, —OCOO—, —CH═CH—, —C═C—, or —C═C—; and

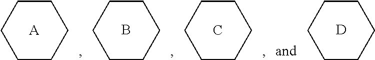

are a same or different, which are selected from: 1,4-phenylene, 1,4-cyclohexylene, 1,4-bicyclo[2,2,2]octyl, pyrimidine-2,5-diyl, naphthalene-2,6-diyl, tetrahydronaphthalene-2,6-diyl, decahydronaphthalene-2,6-diyl, 1,3-dioxane-2,5-diyl or indan-2,5-diyl, and H on the ring may be substituted by alkyl, haloalkyl, alkoxy or halogen.

A mass percentage of the polymerizable monomer is 0.01% to 1%.

The polymerizable monomer further comprises a combination of a liquid crystal composition having a negative dielectric constant. A liquid crystal mixture contains polymerizable monomers, neutral monomers or negative dielectric monomers. A dielectric constant anisotropy (Δε) of the liquid crystal mixture at 25° C. is in a range of −2.0 to −8.0. Because liquid crystals of a VA display mode are negative, it is limited to negative.

The present invention further provides a manufacturing method of a liquid crystal medium composition, comprising following steps of:

a step 1) attaching transparent electrodes to an upper substrate layer and a lower substrate layer, attaching an alignment film to each of the transparent electrodes, and filling the liquid crystal medium composition between the alignment films of the upper substrate layer and the lower substrate layer; wherein at least two polymerizable monomers are mixed in the liquid crystal medium composition, wherein each of the polymerizable monomers comprises at least two ring structures or fused ring structures, and two reactive functional groups directly or indirectly connected to the ring structures; and

a step 2) applying a voltage to the transparent electrodes to deflect a liquid crystal, and irradiating ultraviolet to causes a polymerization reaction of the polymerizable monomers of the liquid crystal medium composition, and orienting liquid crystal molecules to form a pretilt angle, wherein a cross-linking reaction is occurred to form a network polymer.

### Beneficial Effect

The beneficial effects of the present invention are: Compared with the prior art, the present invention provides a liquid crystal display device with improved materials. That is, by using a variety of polymerizable monomers and current PSVA display mode, a purpose of reducing an irradiation time of ultraviolet and increasing a productivity of an HVA process can be achieved by accelerating a polymerization process in the HVA process. At the same time, in the process, a polymer surface formed by the polymerizable monomers is more uniform and protrusion particles are smaller, which reducing a risk of a formation of broken bright spots on a liquid crystal display panel.

In a PSVA process, when a voltage is applied to transparent electrodes on an upper substrate and a lower substrate, liquid crystals are deflected, and a polymerization of the polymerizable monomers is occurred by an irradiation of the ultraviolet. The used liquid crystal composition comprises two or more polymerizable monomers, and each of the polymerizable monomers comprises two or more ring structures or fused ring structures, and two reactive functional groups directly or indirectly connected to the ring structures.

Due to a system of multiple polymerizable monomers used in the present invention, during a PSVA light reaction process, a use of its polycyclic system has stronger UV absorption. Under a same illumination, a reaction activity is stronger, which can increase a polymerization reaction speed and shorten the irradiation time of the ultraviolet. Simultaneously, because it contains two or more ring structures, the polymerizable monomers with a polycyclic structure are more rigid than those with one ring and two rings, and have stronger alignment ability for liquid crystal molecules. Therefore, when a same pretilt angle is reached, the irradiation time of the ultraviolet required for the polymerizable monomers with a polycyclic structure is shorter. Simultaneously, by using a variety of the polymerizable monomers, by adjusting second or third polymerizable monomers to control a number of polymerized molecules, a number of reaction sites increases, so the polymer-forming particles will be smaller. Simultaneously, because it is easier to form a network polymer during the polymerization process, this process can make the polymer film layer denser and more uniformly distributed.

In the present invention, by providing a combination of a liquid crystal component comprising two or more polymerizable monomers and a PSVA display mode, the irradiation time of the ultraviolet of the process is reduced, thereby reducing a tact time and achieving a purpose of increasing productivity. In addition, surfaces of polymers we obtained are more uniform, and particle sizes of the particles are smaller.

### DESCRIPTION OF DRAWINGS

FIG. 1 is a schematic structural view of a liquid crystal display layer of the present invention.

### DETAILED DESCRIPTION OF PREFERRED EMBODIMENTS

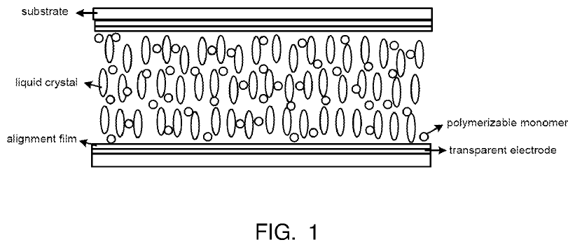

Referring to FIG. 1, the present invention provides an improved liquid crystal display layer comprising an upper substrate layer 1, a lower substrate layer 2, and transparent electrodes 3 disposed inside the upper substrate layer 1 and the lower substrate layer 2, respectively. An alignment film 4 is attached to each of the transparent electrodes 3, and a liquid crystal medium composition 5 is distributed between the alignment films 4. At least two polymerizable monomers are mixed in the liquid crystal medium composition 5, each of the polymerizable monomers comprises at least two ring structures or fused ring structures, and two reactive functional groups directly or indirectly connected to the ring structures. During a manufacturing of polymer-stabilized vertically aligned liquid crystals (PSVA, polmer stabilized vertivally aligned), when a voltage is applied to the transparent electrodes on an upper substrate and a lower substrate, liquid crystals are deflected, and an illumination of the ultraviolet can cause a polymerization of the polymerizable monomers.

A structural formula of the polymerizable monomer is any one or more of following formulas:

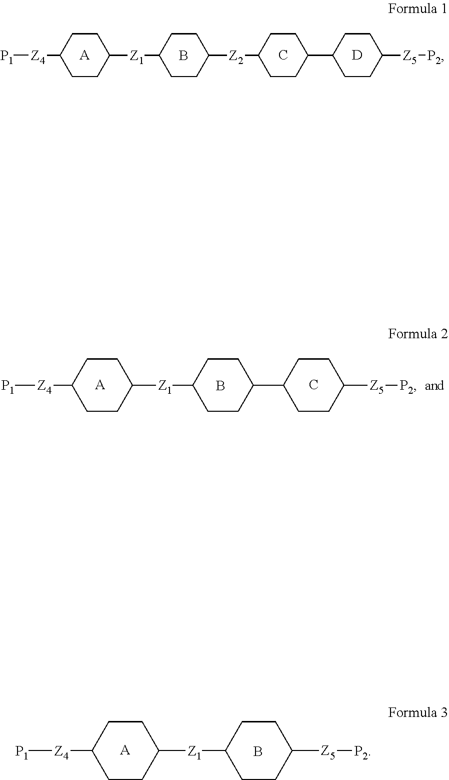

Preferably, the P1 and P2 are a same or different, and are selected from methacrylate, acrylate, vinyloxy, or epoxy; the Z1, Z2, Z3, Z4, and Z5 are a same or different, and are selected from a single bond or an alkylene group having 1 to 5 carbon atoms, wherein any of methylene groups may be replaced by —O—, —S—, —CO—, —COO—, —OCO—, —OCOO—, —CH═CH—, —C═C—, or —C≡C—; and

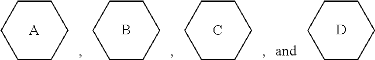

are a same or different, which are selected from: 1,4-phenylene, 1,4-cyclohexylene, 1,4-bicyclo[2,2,2]octyl, pyrimidine-2,5-diyl, naphthalene-2,6-diyl, tetrahydronaphthalene-2,6-diyl, decahydronaphthalene-2,6-diyl, 1,3-dioxane-2,5-diyl or indan-2,5-diyl, and H on the ring may be substituted by alkyl, haloalkyl, alkoxy or halogen.

In the liquid crystal display device, when no external voltage is applied, the liquid crystals are aligned perpendicular to a surface of the alignment film. After the polymer is polymerized, it will be deposited on the surface.

A mass percentage of the polymerizable monomer is 0.01% to 1%.

The polymerizable monomer further comprises a combination of a liquid crystal composition having a negative dielectric constant. A liquid crystal mixture contains polymerizable monomers, neutral monomers or negative dielectric monomers. A dielectric constant anisotropy (Δε) of the liquid crystal mixture at 25° C. is in a range of −2.0 to −8.0. Because liquid crystals of a VA display mode are negative, it is limited to negative.

The present invention further provides a manufacturing method of a liquid crystal medium composition, comprising following steps of:

a step 1) attaching transparent electrodes to an upper substrate layer and a lower substrate layer, attaching an alignment film to each of the transparent electrodes, and filling the liquid crystal medium composition between the alignment films of the upper substrate layer and the lower substrate layer; wherein at least two polymerizable monomers are mixed in the liquid crystal medium composition, wherein each of the polymerizable monomers comprises at least two ring structures or fused ring structures, and two reactive functional groups directly or indirectly connected to the ring structures; and

a step 2) applying a voltage to the transparent electrodes to deflect a liquid crystal, and irradiating ultraviolet to causes a polymerization reaction of the polymerizable monomer of the liquid crystal medium composition, and orienting liquid crystal molecules to form a pretilt angle, wherein a cross-linking reaction is occurred to form a network polymer.

wherein in the step 2), when irradiating the ultraviolet, an intensity of the applied voltage is: 1 V to 36 V, a wavelength range of the ultraviolet is: 200 nm to 400 nm, and an illumination of the ultraviolet is 0.1 mw/cm² to 100 mw/cm².

Different polymer monomers will react simultaneously, which is a free radical polymerization process. The principle is: After power is applied, liquid crystals are tilted, and polymers react to form a polymer network, anchoring the liquid crystal molecules on PI surfaces, thereby forming a liquid crystal molecule alignment. Generally, pre-tilt angles are formed at a first exposure. The exposure time is 10 s to 300 s, and it requires synchronous power currently. A second exposure is then performed to consume remaining polymers and increase product reliability. In a free radical reaction, second/third monomers cannot be controlled, and thus they must be formed before the process. Because the polymerizable monomers have multiple functional groups, they occur a cross-linking reaction and therefore form a network polymer.

At least two polymerizable monomers are mixed in the liquid crystal medium composition of the present invention. Each of the polymerizable monomers comprises at least two ring structures or fused ring structures, and two reactive functional groups directly or indirectly connected to the ring structures.

A structural formula of the polymerizable monomer is any one or more of following formulas:

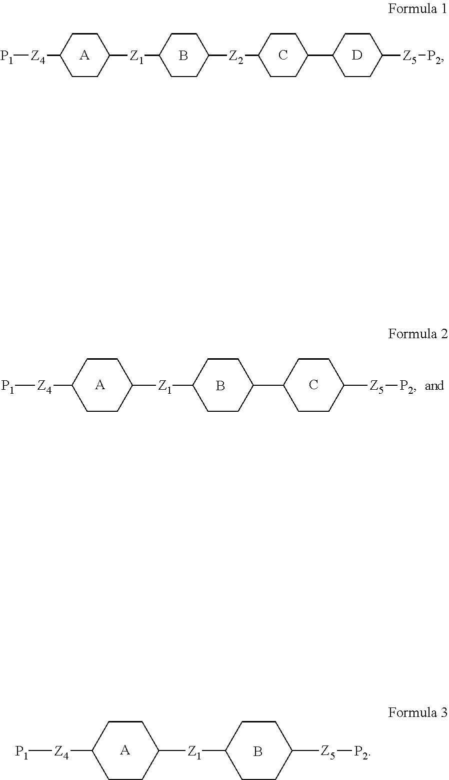

The P1 and P2 are a same or different, and are selected from methacrylate, acrylate, vinyloxy, or epoxy. The Z1, Z2, Z3, Z4, and Z5 are a same or different, and are selected from a single bond or an alkylene group having 1 to 5 carbon atoms, wherein any of methylene groups may be replaced by —O—, —S—, —CO—, —COO—, —OCO—, —OCOO—, —CH═CH—, —C═C—, or —C≡C—.

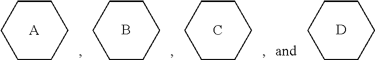

are a same or different, which are selected from: 1,4-phenylene, 1,4-cyclohexylene, 1,4-bicyclo[2,2,2]octyl, pyrimidine-2,5-diyl, naphthalene-2,6-diyl, tetrahydronaphthalene-2,6-diyl, decahydronaphthalene-2,6-diyl, 1,3-dioxane-2,5-diyl or indan-2,5-diyl, and H on the ring may be substituted by alkyl, haloalkyl, alkoxy or halogen.

The following specifically provides a combination of Formula 1, Formula 2, and Formula 3, and reaction formulas of the polymerization reaction according to a pairwise polymerization or three polymerizations together are listed in detail below.

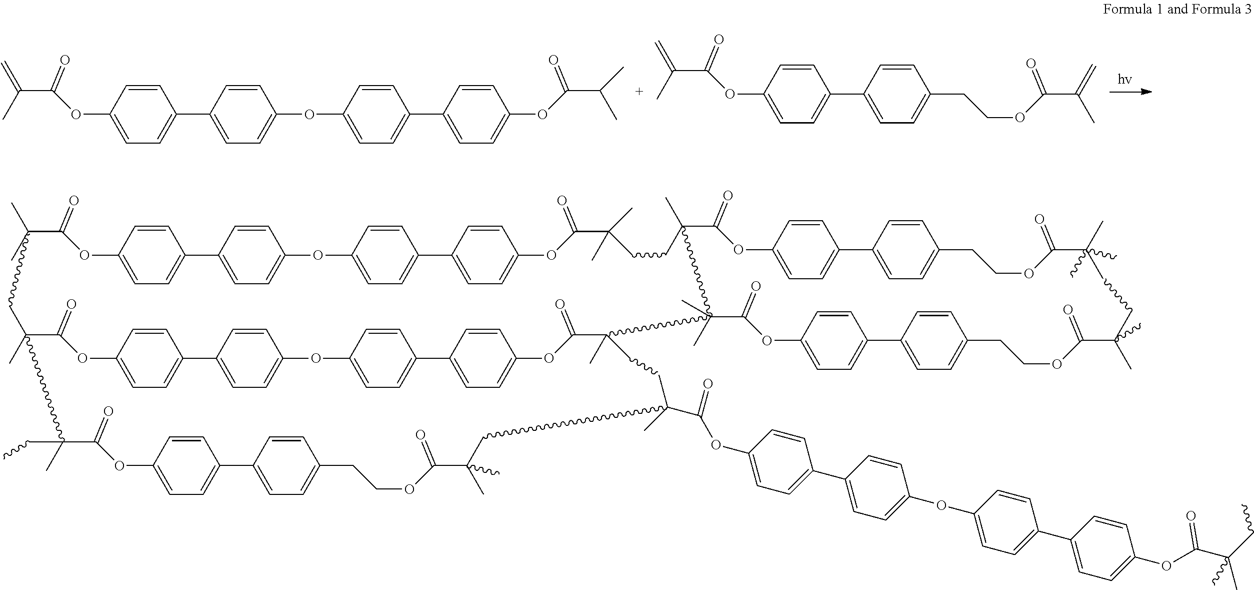

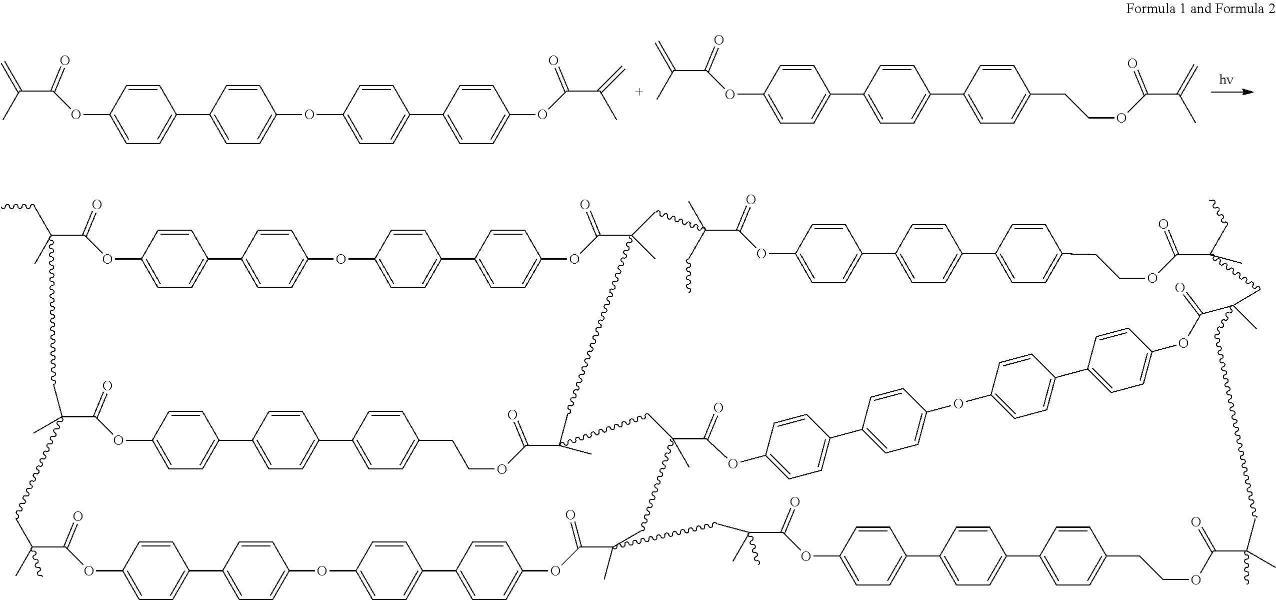

Polymerization reaction of Formula 1, Formula 2, and Formula 3:

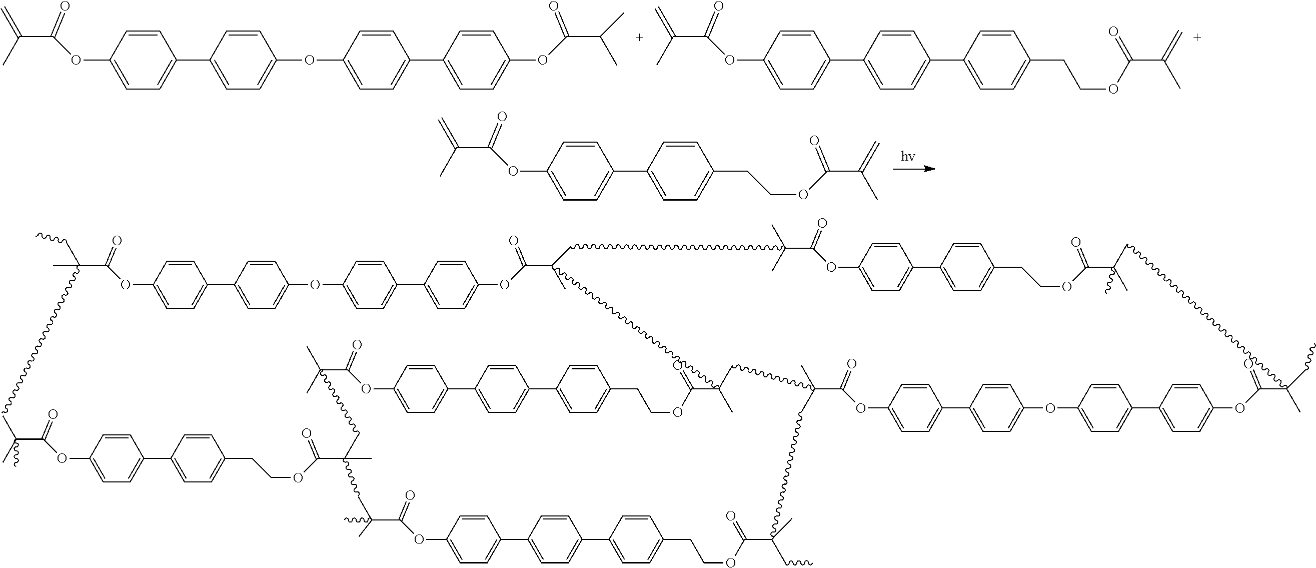

In the present invention, a pairwise polymerization and a polymerization reaction of three structures can occur between Formula 1, Formula 2, and Formula 3, and the degree of polymerization is above 1000. Of the three different polymerization methods, if a shorter polymerization time is required, the three mixtures are preferentially polymerized with each other, and followed by the polymerization reaction between Formula 1 and Formula 2. After the polymerization, a liquid crystal host medium does not change, and the liquid crystal host does not participate in the reaction.

What is claimed is:

1. A liquid crystal display layer, comprising:
an upper substrate layer, a lower substrate layer, and transparent electrodes disposed inside the upper substrate layer and the lower substrate layer, respectively;
wherein an alignment film is attached to each of the transparent electrodes, and a liquid crystal medium composition is distributed between the alignment films; and
wherein at least two polymerizable monomers are mixed in the liquid crystal medium composition, each of the polymerizable monomers comprises at least two ring structures or fused ring structures, and two reactive functional groups directly or indirectly connected to the ring structures.

2. The liquid crystal display layer as claimed in claim 1, wherein a structural formula of the polymerizable monomer is any one or more of following formulas:

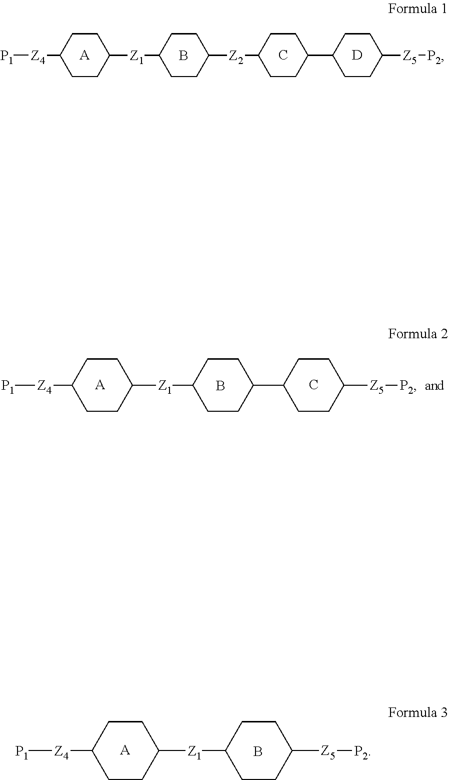

3. The liquid crystal display layer as claimed in claim 2, wherein the P1 and P2 are a same or different, and are selected from methacrylate, acrylate, vinyloxy, or epoxy;
the Z1, Z2, Z3, Z4, and Z5 are a same or different, and are selected from a single bond or an alkylene group having 1 to 5 carbon atoms, wherein any of methylene groups may be replaced by —O—, —S—, —CO—, —COO—, —OCO—, —OCOO—, —CH═CH—, —C═C—, or —C≡C—; and 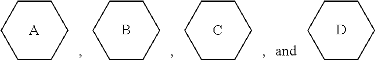
are a same or different, which are selected from: 1,4-phenylene, 1,4-cyclohexylene, 1,4-bicyclo[2,2,2]octyl, pyrimidine-2,5-diyl, naphthalene-2,6-diyl, tetrahydronaphthalene-2,6-diyl, decahydronaphthalene-2,6-diyl, 1,3-dioxane-2,5-diyl or indan-2,5-diyl, and H on the ring may be substituted by alkyl, haloalkyl, alkoxy or halogen.

4. The liquid crystal display layer as claimed in claim 2, wherein a mass percentage of the polymerizable monomer is 0.01% to 1%.

5. The liquid crystal display layer as claimed in claim 2, wherein the polymerizable monomer further comprises a combination of a liquid crystal composition having a negative dielectric constant.

6. A liquid crystal medium composition for a liquid crystal display layer, comprising:
at least two polymerizable monomers mixed in the liquid crystal medium composition, wherein each of the polymerizable monomers comprises at least two ring structures or fused ring structures, and two reactive functional groups directly or indirectly connected to the ring structures.

7. The liquid crystal medium composition as claimed in claim 6, wherein a structural formula of the polymerizable monomer is any one or more of following formulas:

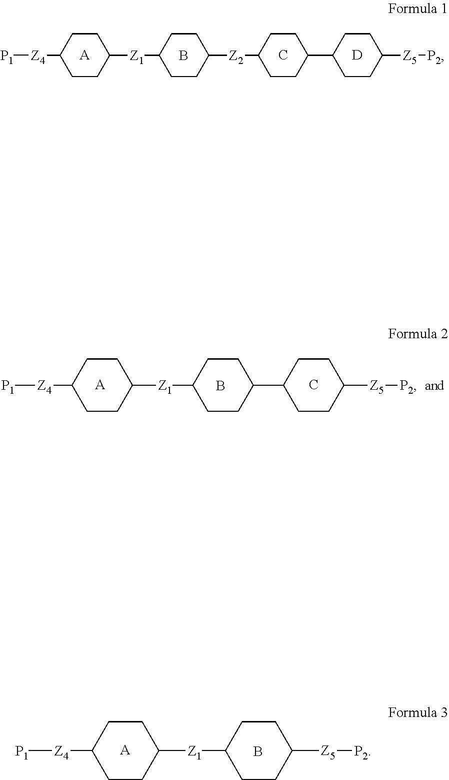

8. The liquid crystal medium composition as claimed in claim 7, wherein the P1 and P2 are a same or different, and are selected from methacrylate, acrylate, vinyloxy or epoxy;
the Z1, Z2, Z3, Z4, and Z5 are a same or different, and are selected from a single bond or an alkylene group having 1 to 5 carbon atoms, wherein any of methylene groups may be replaced by —O—, —S—, —CO—, —COO—, —OCO—, —OCOO—, —CH═CH—, —C═C—, or —C≡C—; and 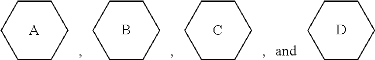
are a same or different, which are selected from: 1,4-phenylene, 1,4-cyclohexylene, 1,4-bicyclo[2,2,2]octyl, pyrimidine-2,5-diyl, naphthalene-2,6-diyl, tetrahydronaphthalene-2,6-diyl, decahydronaphthalene-2,6-diyl, 1,3-dioxane-2,5-diyl or indan-2,5-diyl, and H on the ring may be substituted by alkyl, haloalkyl, alkoxy or halogen.

9. A manufacturing method of a liquid crystal medium composition, comprising following steps of:
a step 1) attaching transparent electrodes to an upper substrate layer and a lower substrate layer, attaching an alignment film to each of the transparent electrodes, and filling the liquid crystal medium composition between the alignment films of the upper substrate layer and the lower substrate layer;
wherein at least two polymerizable monomers are mixed in the liquid crystal medium composition, wherein each of the polymerizable monomers comprises at least two ring structures or fused ring structures, and two reactive functional groups directly or indirectly connected to the ring structures; and
a step 2) applying a voltage to the transparent electrodes to deflect a liquid crystal, and irradiating ultraviolet to causes a polymerization reaction of the polymerizable monomer of the liquid crystal medium composition, and orienting liquid crystal molecules to form a pretilt angle, wherein a cross-linking reaction is occurred to form a network polymer.

10. The manufacturing method of the liquid crystal medium composition as claimed in claim 9, wherein in the step 2), when irradiating ultraviolet, an intensity of the applied voltage is: 1 V to 36 V, a wavelength range of the ultraviolet is: 200 nm to 400 nm, and an illumination of the ultraviolet is 0.1 mw/cm² to 100 mw/cm².
